(19) United States
(12) Patent Application Publication
(10) Pub. No.: US 2026/0340461 A1
(43) Pub. Date: Oct. 29, 2026

(54) SYSTEMS AND METHODS FOR PROBABILISTIC ESTIMATION IN TREE-BASED FORECAST MODELS

(71) Applicant: Kinaxis Inc., Ottawa (CA)

(72) Inventors: Sebastien Ouellet, Freiburg im Breisgau (DE); Ali Khanafer, Chicago, IL (US); Christopher Wang, Ottawa (CA); Carter Demars, Ottawa (CA)

(73) Assignee: Kinaxis Inc., Ottawa, ON (CA)

(21) Appl. No.: 19/660,601

(22) Filed: Apr. 28, 2026

Related U.S. Application Data
(60) Provisional application No. 63/795,714, filed on Apr. 28, 2025.

(51) Int. Cl. G06N 7/01; G06N 20/00

(52) U.S. Cl. CPC G06N 7/01; G06N 20/00

(57) ABSTRACT

Systems and methods estimate a probability distribution for a forecasted quantity by embedding a training dataset from a trained tree-based model as vectors, where each sample is a vector and each dimension encodes a decision point in the model. Historical-sample distance is defined using cosine similarity. The vector array is indexed with a Hierarchical Navigable Small World (HNSW) structure; for a new prediction, the index is searched to find vectors most similar to the new prediction's vector, yielding a discrete probability distribution of the forecasted quantity, including quantiles for a product across multiple locations. Tradeoff curves are built for each product-location combination from the quantile predictions. An objective function accepts quantities per location and computes an objective metric from the tradeoff curves.

This application claims priority on U.S. Ser. No. 63/795,714 filed on Apr. 28, 2025, which is incorporated herein in its entirety, by reference.

### BACKGROUND

From a technical perspective, the conventional approach to forecasting a range (rather than a single point) in a machine learning model, is to use traditional time series models, such as Autoregressive Integrated Moving Average (ARIMA), since these inherently produce prediction intervals. However, ARIMA models are not always accurate, and can be computationally unstable. Other conventional approaches for forecasting a range of values (rather than a single point), include neural networks and Bayesian models. However, these have the drawback in that they are expensive and harder to tune. In fact, all of the conventional approaches for forecasting a range of values, require more data, more run-time, and are overall, computationally resource-intensive.

While tree-based models are computationally efficient and fast, conventional uses of tree-based models do not forecast a range of values. That is, conventional use of tree-based models does not provide a probability of forecasts.

There is use of tree-based models in a non-conventional approach that results in probability forecasts, that is less data-intensive, requires less run-time and is more computationally efficient than the Bayesian models, neural networks and traditional time series models used for probability forecasts. Such a non-conventional approach also includes gradient boosted machines. In such a non-conventional approach, historical data set is pre-processed once per trained machine-learning model; a value of an unknown sample is forecast while tracking a leaf path of the unknown sample; the leaf path of the unknown sample is limited to a subset of trees in each trained-machine model; a set of related historical samples is determined based on the leaf path of the unknown sample, and a set of quantiles is determined from the leaf path of the unknown sample. In summary, such an approach relies on tracking leaf paths.

However, this non-conventional method may not be practical for producing accurate prediction intervals for many millions of time series. The leaf-tracking approach becomes cost-prohibitive and slow.

### BRIEF SUMMARY

There is thus a need to provide a range of forecasts in machine learning, in a manner that is computationally efficient, and avoids the slow performance and costliness of a leaf-tracking approach when trying to predict intervals for many millions of time series.

The systems and methods disclosed herein relate to an estimation of the probability of a forecasted quantity in a computationally efficient manner. The systems and methods disclosed herein may be presented in two parts. One part relates to systems and methods of estimating the probability of a forecasted value.

A second, optional use case afforded by the first part, discloses systems and methods where values used by a process are optimized. In both parts, there is no restriction as to the context of the values. While there is no restriction as to the context of the quantities, non-limiting examples in the field of supply chain management are provided.

The disclosure describes a technical method for improving machine learning forecasting using vector embeddings, cosine similarity, and Hierarchical Navigable Small World indexes; presence of specific technical features enhance computational efficiency and solve a technical problem (avoiding slow leaf-tracking).

In one aspect, a computing apparatus is provided, that includes a processor. The computing apparatus also includes a memory storing instructions that, when executed by the processor, configure the apparatus to: embed a training dataset of a trained tree-based model as an array of vectors, each vector corresponding to a respective sample of the training dataset and each dimension of the vector representing a decision point in the trained tree-based model; define a distance between historical sample points in a time series as a cosine similarity function between the vectors; process the array of vectors through a Hierarchical Navigable Small World index to produce an approximate view of similar vectors; for a new prediction, search the Hierarchical Navigable Small World index for vectors most similar to a vector associated with the new prediction; create, from the vectors most similar to the vector associated with the new prediction, a discrete probability distribution of a forecasted quantity; compute quantile predictions for a product across multiple locations based on the discrete probability distribution; construct tradeoff curve functions for each combination of product and location from the quantile predictions; and construct an objective function that accepts a quantity per location and computes an objective metric from the tradeoff curves.

The computing apparatus may also include where the instructions further configure the apparatus to sample, from the discrete probability distribution to produce a prediction interval. The computing apparatus may also include where the trained tree-based model includes a gradient boosting model. The computing apparatus may also include where when embedding the training dataset as the array of vectors, the instructions further configure the apparatus to normalize dimensions of the vectors across different tree depths. The computing apparatus may also include where when searching the Hierarchical Navigable Small World index, the instructions further configure the apparatus to retrieve between one hundred and one hundred and fifty most similar vectors. The computing apparatus may also include where, when searching the Hierarchical Navigable Small World index, the instructions further configure the apparatus to retrieve one hundred most similar vectors. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: embed a training dataset of a trained tree-based model as an array of vectors, each vector corresponding to a respective sample of the training dataset and each dimension of the vector representing a decision point in the trained tree-based model; define a distance between historical sample points in a time series as a cosine similarity function between the vectors; process the array of vectors through a Hierarchical Navigable Small World index to produce an approximate view of similar vectors, for a new prediction; search the Hierarchical Navigable Small World index for vectors most similar to a vector associated with the new prediction; create, from the vectors most similar to the vector associated with the new prediction, a discrete probability distribution of a forecasted quantity; compute quantile predictions for a product across multiple locations based on the discrete probability distribution; construct tradeoff curve functions for each combination of product and location from the quantile predictions; and construct an objective function that accepts a quantity per location and computes an objective metric from the tradeoff curves.

The computer-readable storage medium may also include where the instructions further configure the computer to sample from the discrete probability distribution to produce a prediction interval. The computer-readable storage medium may also include where the trained tree-based model includes a gradient boosting model. The computer-readable storage medium may also include where when embedding the training dataset as the array of vectors, the instructions further configure the computer to normalize dimensions of the vectors across different tree depths. The computer-readable storage medium may also include where when searching the Hierarchical Navigable Small World index, the instructions further configure the computer to retrieve between one hundred and one hundred and fifty most similar vectors. The computer-readable storage medium may also include where when searching the Hierarchical Navigable Small World index, the instructions further configure the computer to retrieve one hundred most similar vectors. Other technical features may be readily apparent to one skilled in the art from the following figures, descriptions, and claims.

In one aspect, a computer-implemented method for estimating a probability distribution of a forecasted quantity is provided, the method includes: embedding, by a processor, a training dataset of a trained tree-based model as an array of vectors, each vector corresponding to a respective sample of the training dataset and each dimension of the vector representing a decision point in the trained tree-based model; defining, by the processor, a distance between historical sample points in a time series as a cosine similarity function between the vectors; processing, by the processor, the array of vectors through a Hierarchical Navigable Small World index to produce an approximate view of similar vectors, for a new prediction; searching, by the processor, the Hierarchical Navigable Small World index for vectors most similar to a vector associated with the new prediction; creating, by the processor, from the vectors most similar to the vector associated with the new prediction, a discrete probability distribution of the forecasted quantity; computing, by the processor, quantile predictions for a product across multiple locations based on the discrete probability distribution; constructing, by the processor, tradeoff curve functions for each combination of product and location from the quantile predictions; and constructing, by the processor, an objective function that accepts a quantity per location and computes an objective metric from the tradeoff curves.

The computer-implemented method may also further include sampling, by the processor, from the discrete probability distribution to produce a prediction interval. The computer-implemented method may also include where the trained tree-based model includes a gradient boosting model. The computer-implemented method may also include where embedding the training dataset as the array of vectors includes normalizing dimensions of the vectors across different tree depths. The computer-implemented method may also include where searching the Hierarchical Navigable Small World index includes retrieving between one hundred and one hundred and fifty most similar vectors. The computer-readable storage medium may also include where when searching the Hierarchical Navigable Small World index, the instructions further configure the computer to retrieve one hundred most similar vectors. Other technical features may be readily apparent to one skilled in the art from the following figures, descriptions, and claims.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Like reference numbers and designations in the various drawings indicate like elements.

FIG. 1 illustrates an example of a system for probabilistic estimation in tree-based forecast models in accordance with one embodiment.

FIG. 2 illustrates a flowchart for an uncertainty estimation from a trained model in accordance with one embodiment.

FIG. 3 illustrates a flowchart for training a decision tree machine-learning model in accordance with one embodiment.

FIG. 4 illustrates a trained tree-based forecast model in accordance with one embodiment.

FIG. 5 illustrates a flowchart for an uncertainty estimation from a trained model in accordance with one embodiment.

FIG. 6 illustrates a flowchart for an uncertainty estimation from a trained model in accordance with one embodiment.

FIG. 7 illustrates a flowchart for optimization of service levels in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

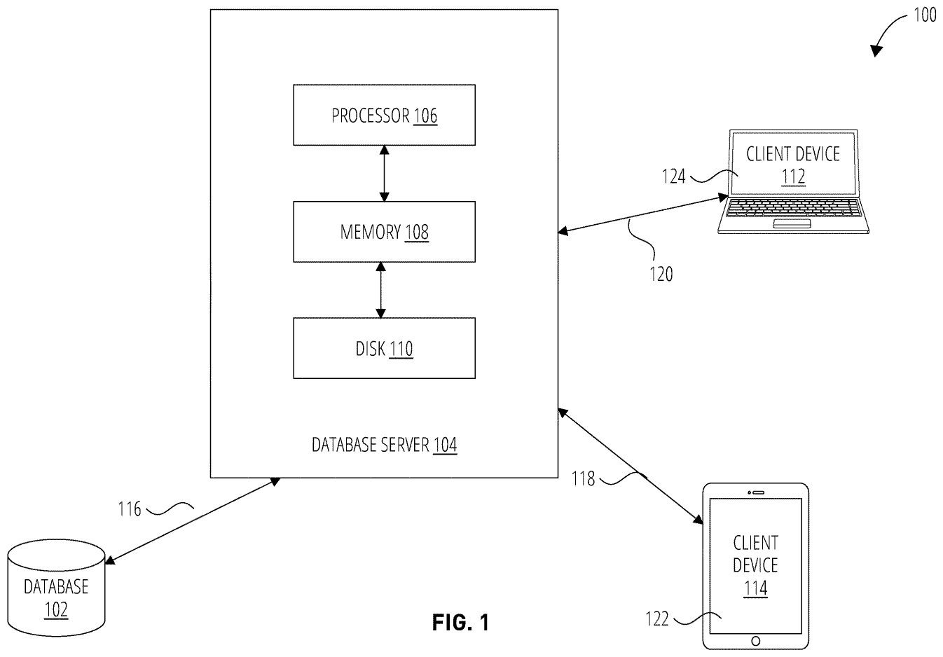

FIG. 1 illustrates an example of a system 100 for probabilistic estimation in tree-based forecast models.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

From a technical perspective, the conventional approach to forecasting a range (rather than a single point) in a machine-learning model, is to use traditional time series models, such as Autoregressive Integrated Moving Average (ARIMA), since it inherently produces prediction intervals. However, ARIMA models are not always accurate, and can be computationally unstable. Other conventional approaches for forecasting a range of values (rather than a single point), include neural networks and Bayesian machine-learning models. However, these have the drawback in that they are expensive and harder to tune. In fact, all of the conventional approaches for forecasting a range of values, require more data, more run-time, and are overall, computationally resource-intensive.

On the other hand, while tree-based machine-learning models are computationally efficient and fast, conventional uses of tree-based machine-learning models do not forecast a range. That is, conventional use of tree-based machine-learning models does not provide a probability of forecasts. It is therefore not obvious that tree-based machine-learning models can be used to provide a probability of forecasts.

However, systems and methods disclosed herein, use tree-based models in a non-conventional way that results in probability forecasts. Furthermore, such a unique approach is less data-intensive, requires less run-time and is more computationally efficient than the Bayesian models, neural networks and traditional time series machine-learning models.

The systems and methods disclosed herein relate to an estimation of the probability of a forecasted quantity. The systems and methods disclosed herein may be presented in two parts. One part relates to systems and methods of estimating the probability of a forecasted value. A second, optional use case afforded by the first part, discloses systems and methods where values used by a process are optimized.

In both parts, there is no restriction as to the context of the values. While there is no restriction as to the context of the quantities, non-limiting examples in the field of supply chain management are provided. Systems and methods related to the optional use case can comprise: an optimization module using the quantiles to produce a set of recommendations.

The methods and systems disclosed herein are an improvement on conventional approaches by enhancing a number of features. For example, accuracy is enhanced, as a desired coverage probability is achieved with a short window of historical data. Simultaneously, since a short window of historical data is required (as opposed to conventional methods described above), less historical data is required for processing, thereby reducing both processing time and data storage.

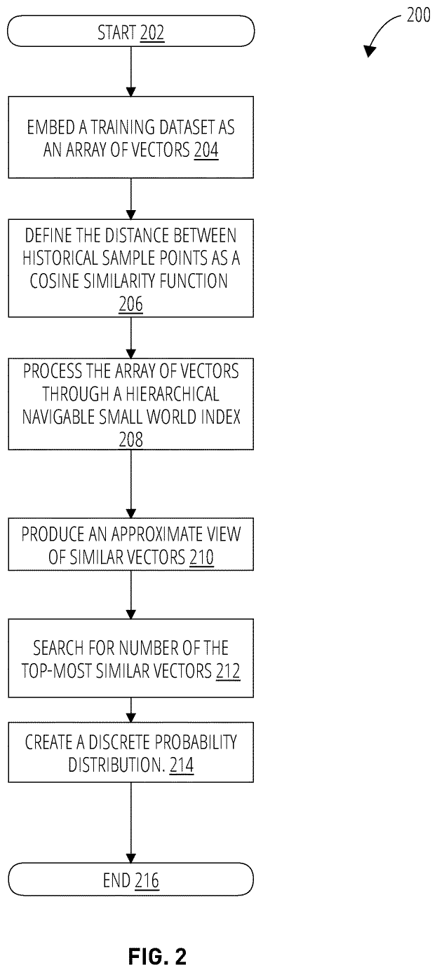

FIG. 2 illustrates a flowchart 200 for an uncertainty estimation from a trained model in accordance with one embodiment.

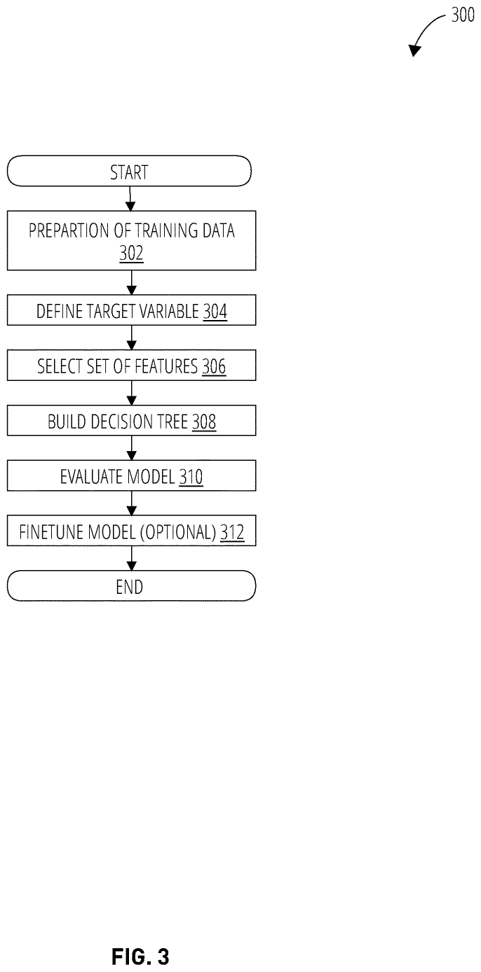

At block 204, the training dataset of a trained tree-based model is embedded as an array of vectors, where each dimension represents a decision point in the model. An example of a block diagram for training a tree-based model is illustrated in FIG. 3. In FIG. 2, decision paths of a trained tree-based model are converted into an array of vectors where each dimension corresponds to a specific decision point within the model structure. Such an approach transforms complex tree logic into a format compatible with high-speed vector search algorithms, enabling the retention of model interpretability while gaining computational efficiency. Dimensions of the vector can be normalized to ensure consistent distance calculations across different tree depths, since this approach is applicable within a single model. Therefore, all embeddings have the same size as all samples of the training set and of the prediction set are seen by the same model.

With regards to memory overhead of storing these vectors compared to the original tree structure, memory overhead can be adjustable as embeddings are natively hierarchical: the first dimensions encode larger potential differences in similarity. This is due to how gradient-boosted tree ensembles are trained sequentially and weighted according to that sequence: the earlier trees are more important for the final prediction than later trees. Therefore, depending on storage, speed and accuracy concerns, the size of the embeddings can be adjusted up to the total number of trees in the model.

Next, at block 206, the distance between historical sample points in a time series is defined as the cosine similarity function between two of these vectors. Use of cosine similarity allows the system to focus on the directional pattern of the data rather than absolute magnitude, which improves robustness against scale variations in time series data. There is no need to adjust the similarity metric dynamically based on the volatility of a specific time series, since the system is agnostic to the properties of the time series.

Subsequently, at block 208, the array of vectors is processed through a Hierarchical Navigable Small World (HNSW) index to create an approximate view of similar vectors for rapid retrieval. HNSW indexing drastically reduces the search time complexity from linear to logarithmic, making it feasible to generate accurate prediction intervals for millions of time series without prohibitive latency.

While index creation can take longer than querying it once for all time series in a dataset, operations are still completed within a minute for the production workload datasets. Once an index is created, it is possible to reuse it until a new model is trained which may be multiple days or weeks and the fast queries then allow users to investigate their time series similarity questions without considerable wait times.

This produces, at block 210, an approximate view of similar vectors. At block 212, given a new prediction, search for the top-most similar vectors. For example, this can include the top one-hundred most similar vectors.

After retrieving the top similar vectors at block 212 the system constructs a discrete probability distribution from these search results at block 214, to estimate the likelihood of forecasted quantities. This method provides a full probability distribution rather than a single point estimate, allowing downstream tasks to quantify uncertainty and optimize decisions based on risk profiles.

In some embodiments, typical weighting of retrieved neighbors can be directly proportional to the cosine similarity between the new prediction sample and the samples returned by the index. In addition, the size of the retrieved neighbor set may be tuned per application automatically to deliver the right tradeoff in terms of speed and prediction quality.

A number of technical effects ensue from the steps outlined in FIG. 2. Embedding the training dataset of a trained tree-based model as an array of vectors, with each dimension representing a decision point in the model, allows the decision paths of the model to be expressed in a form that is compatible with vector-based processing. This arrangement enables the system to preserve information about how samples traverse the trained model while supporting high-speed similarity operations on a common vector representation. Where the vector dimensions are normalized and the embedding size is selected according to storage, speed, or accuracy considerations, the representation also supports consistent distance calculations across tree depths and permits memory usage to be adjusted without departing from the underlying model structure.

In addition, defining the distance between historical sample points as a cosine similarity function between the vectors allows the comparison to emphasize directional similarity in the embedded decision-path patterns rather than magnitude alone. This comparison approach improves robustness to scale variation in the time-series data and reduces the need to tailor the similarity metric to the volatility characteristics of individual time series. As a result, the same similarity formulation can be applied across different series while still supporting reliable identification of historically relevant samples.

In addition, processing the array of vectors through a Hierarchical Navigable Small World index allows the embedded samples to be organized in a structure that supports approximate neighbor retrieval at production scale. This indexing step enables rapid access to similar vectors without requiring full comparison across the training dataset, thereby reducing search burden and making interval-oriented forecasting practical for large numbers of time series. Because the index may be reused until the model is retrained, the arrangement also supports repeated querying with limited additional overhead.

In addition, searching, for a new prediction, for a number of most similar vectors allows the system to retrieve a focused set of historical samples that are most relevant to the current prediction context. This step enables the subsequent uncertainty estimation to be based on a bounded neighbor set rather than the entire historical population, which improves computational efficiency while maintaining a controllable balance between speed and prediction quality. Where the number of retrieved vectors is selected or tuned for a given application, the search can be adapted to the desired operational tradeoff without changing the overall probabilistic estimation workflow.

Furthermore, creating a discrete probability distribution from the retrieved similar vectors allows the system to produce a probabilistic characterization of the forecasted quantity instead of a single point forecast alone. This distribution enables downstream processing, including sampling to form a prediction interval and using the forecast output in risk-sensitive decision tasks. Because the distribution is derived from a common set of similar historical samples returned through the vector-based search process, the resulting probabilistic output also supports internally consistent interval and quantile estimation.

Further technical effects ensue from some embodiments.

In some embodiments, where a gradient boosting model is used as the trained tree-based model, allows the probabilistic estimation process to be applied to an ensemble in which trees are built sequentially and contribute with different relative weighting. This arrangement supports computationally efficient generation of probability forecasts and prediction intervals while avoiding reliance on leaf-tracking operations that become slow and costly at large scale. The sequential weighting of the trees also permits the embedding size to be adjusted according to storage, speed, and accuracy considerations.

In addition, in some embodiments, where dimensions of the vectors are normalized across different tree depths, allows for distance calculations between embedded samples to remain consistent even when decision points occur at different depths in the trained model. This step enables reliable similarity comparison in the vector space and supports use of a common embedding format for training samples and prediction samples. As a result, the embedded representation remains suitable for high-speed vector search while preserving the structure derived from the tree-based model.

In addition, in some embodiments, one hundred most similar vectors from the Hierarchical Navigable Small World index are retrieved, which allows the method to use a defined set of nearby historical samples when constructing the discrete probability distribution for a new prediction. This retrieval size supports a practical balance between search speed and prediction quality, rather than requiring a full comparison against the dataset. In combination with the indexed similarity search, the feature helps maintain rapid processing for large forecasting workloads.

Furthermore, in some embodiments, the retrieved similar vectors are weighted in proportion to their respective cosine similarities to the vector of the new prediction, which allows historical samples that are more closely aligned with the new prediction to have greater influence on the resulting discrete probability distribution. This weighting improves the relevance of the distribution to the current prediction context and supports more informative uncertainty estimation. The feature also works with the similarity-based retrieval process to preserve a useful tradeoff between prediction quality and processing efficiency.

FIG. 3 illustrates a flowchart 300 for training a decision tree machine-learning model in accordance with one embodiment.

At block 302, the training data is prepared. This can include cleaning, preprocessing, and splitting historical data into training and testing sets. Next, at block 304, the target variable is defined. That is, the variable that is going to be forecast, is identified. This can include, for example, a class label or a continuous value. Feature selection takes place at block 306. Here, a set of features are selected, that are relevant to the target variable and can provide an information gain or the a reduction in uncertainty.

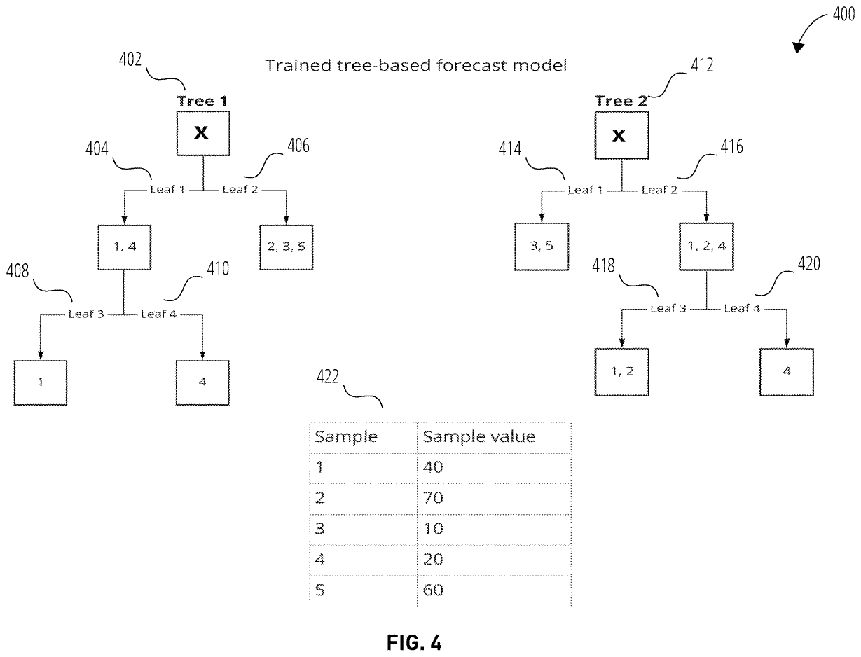

At block 308, a decision tree is built. This may include: starting with the root node, split the data recursively into smaller subsets using the selected features until a stopping criterion is met. The stopping criterion can be based on a maximum depth of the tree, a minimum number of samples required to split a node, or other criteria. Finally, at block 310, the trained machine-learning model is evaluated. The model's performance can be evaluated on the testing data using appropriate metrics such as accuracy, precision, recall, F1 score, mean-squared error, or other metrics known in the art. The model can be optionally tuned at block 312, by adjusting hyperparameters, selecting different features or combinations of features, or using ensemble methods. The trained decision tree model is ready to forecast on new data. A simple example of a trained tree-based forecast model is presented in FIG. 4.

FIG. 4 illustrates a trained tree-based forecast model 400 in accordance with one embodiment.

The structure of Tree 402 is as follows. At the first level of branching, there are two leaves: Leaf 404 and Leaf 406. Each of Leaf 404 and 406 are separated according to a respective feature. For example, Leaf 404 can indicate that a sample value occurred on a weekend (that is, Saturday and Sunday), while Leaf 406 can indicate that a sample value occurred on a weekday (that is, Monday-Friday). There is a second branch at Leaf 404, giving rise to Leaf 408 and Leaf 410, each of which is distinguished by a respective feature. For example, Leaf 408 can indicate that a sample value occurred on a Saturday, while Leaf 410 can indicate that a sample value occurred on a Sunday.

The structure of Tree 412 is as follows. At the first level of branching, there are two leaves: Leaf 414 and Leaf 416. Each of Leaf 414 and Leaf 416 are separated according to a respective feature. For example, Leaf 414 can indicate that a sample value occurred in the first half of the year (that is, January-June), while Leaf 416 can indicate that a sample value occurred in the second half of the year (that is, July-December). There is a second branch at Leaf 416, giving rise to Leaf 418 and Leaf 420, each of which is distinguished by a respective feature. For example, Leaf 418 can indicate that a sample value occurred in the third quarter (that is, July-September), while Leaf 420 can indicate that a sample value occurred in the fourth quarter (that is, October-December).

The illustration of Tree 402 also shows data that is used for training a tree-based forecast model. Namely, sample values 1-5 (shown in sample value table 422), in which Sample 1 has a value of 40; Sample 2 has a value of 70; Sample 3 has a value of 10; Sample 4 has a value of 20; and Sample 5 has a value of 60. Each sample also has associated with it, a set of features (which are not shown in sample value table 422). For example, these features can indicate information about the sample value: when it occurred, its geographical location; financial market conditions, etc. Examples of features can include the day of the week, the month, the quarter, the year, seasonal conditions (summer, fall, winter, spring), proximity to a holiday, climate conditions, stock market indices, etc. Historical data is sorted by each tree, according to the data's features.

Each sample is then processed through Tree 402. For example, after the first branch, samples 1 and 4 are closer with respect to a first feature than samples 2, 3 and 5, while samples 2, 3 and 5 are mutually closer with respect to a second feature than samples 1 and 4. As an example, suppose Tree 402 samples a subset of features related to the time of occurrence, such that Leaf 404 is for all occurrences on a weekend, while Leaf 406 is for all occurrences on a weekday. According to FIG. 4, samples 1 and 4 are grouped together (in Leaf 404) since they each have a weekend as a feature, whereas samples 2, 3 and 5 are grouped together (in Leaf 406) since they each have a weekday as a feature. At the next branch level, Leaf 408 is associated with a third feature, while Leaf 410 is associated with a fourth feature. Continuing the aforementioned example, if Leaf 408 indicates occurrence on a Saturday, and Leaf 410 indicates occurrence on a Sunday, then sample 1 is grouped in Leaf 408 since it has Saturday as a feature, whereas sample 4 is grouped in Leaf 420 since it has Sunday as a feature.

Each sample can then also be processed through Tree 412. For example, after the first branch, samples 3 and 5 are closer with respect to a first feature than samples 1, 2 and 4, while samples 1,2 and 4 are mutually closer with respect to a second feature than samples 3 and 5. As an example, suppose Tree 412 samples a subset of features related to time of occurrence, such that Leaf 414 is for all occurrences in the first six months (January-June), while Leaf 416 is for all occurrences in the last six months (July-December). According to FIG. 4, samples 3 and 5 are grouped together (in Leaf 414) since they each occur during the first six months as a feature, whereas samples 1, 2 and 4 are grouped together (in Leaf 416) since they occur during the last six months as a feature. At the next branch level, Leaf 418 is associated with a third feature, while Leaf 420 is associated with a fourth feature. Continuing the aforementioned example, if Leaf 418 indicates occurrence in the third quarter (July-September), and Leaf 420 indicates occurrence in the fourth quarter (October-December) then samples 1 and 2 are grouped in Leaf 418 since they each have the third quarter as a feature, whereas sample 4 is grouped in Leaf 420 since it has the fourth quarter as a feature.

In FIG. 4, the entity marked ‘X’ refers to a sample with an unknown sample value. The sample ‘X” can be used by the trained tree-based forecast model 400 to forecast a sample value within a confidence interval.

In FIG. 4, while two trees are provided as examples, it is understood that the model incorporates a far greater number of trees, numbering in the hundreds, thousands, tens-of-thousands, etc. Furthermore, each tree can include any number of branches, while each tree can use different subsets of features of all the data present.

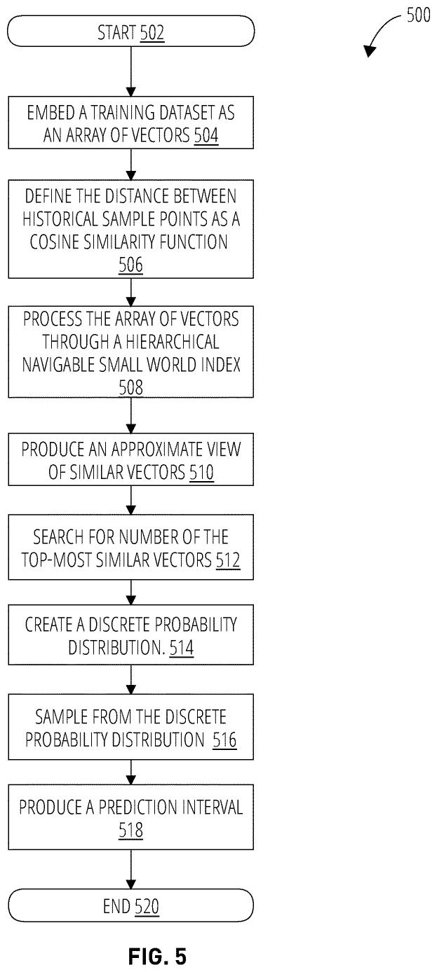

FIG. 5 illustrates a flowchart 500 for an uncertainty estimation from a trained model in accordance with one embodiment. Flowchart 500 includes further steps from those shown in flowchart 200 in FIG. 2.

At block 504, the training dataset of a trained tree-based model is embedded as an array of vectors, where each dimension represents a decision point in the model. An example of a block diagram for training a tree-based model is illustrated in FIG. 3.

In FIG. 5, decision paths of a trained tree-based model can be converted into an array of vectors where each dimension corresponds to a specific decision point within the model structure. Such an approach transforms complex tree logic into a format compatible with high-speed vector search algorithms, enabling the retention of model interpretability while gaining computational efficiency. Dimensions of the vector can be normalized to ensure consistent distance calculations across different tree depths, since this approach is applicable within a single model. Therefore, all embeddings have the same size as all samples of the training set and of the prediction set are seen by the same model.

With regards to memory overhead of storing these vectors compared to the original tree structure, memory overhead can be adjustable as embeddings are natively hierarchical: the first dimensions encode larger potential differences in similarity. This is due to how gradient-boosted tree ensembles are trained sequentially and weighted according to that sequence: the earlier trees are more important for the final prediction than later trees. Therefore, depending on storage, speed and accuracy concerns, the size of the embeddings can be adjusted up to the total number of trees in the model.

Next, at block 506, the distance between historical sample points in a time series is defined as the cosine similarity function between two of these vectors. Use of cosine similarity allows the system to focus on the directional pattern of the data rather than absolute magnitude, which improves robustness against scale variations in time series data. There is no need to adjust the similarity metric dynamically based on the volatility of a specific time series, since the system is agnostic to the properties of the time series.

Subsequently, at block 508, the array of vectors is processed through a Hierarchical Navigable Small World (HNSW) index to create an approximate view of similar vectors for rapid retrieval. HNSW indexing drastically reduces the search time complexity from linear to logarithmic, making it feasible to generate accurate prediction intervals for millions of time series without prohibitive latency.

While index creation can take longer than querying it once for all time series in a dataset, operations are still completed within a minute for the production workload datasets. Once an index is created, it is possible to reuse it until a new model is trained which may be multiple days or weeks and the fast queries then allow users to investigate their time series similarity questions without considerable wait times.

This produces, at block 510, an approximate view of similar vectors. At block 212, given a new prediction, search for the top-most similar vectors. For example, this can include the top one-hundred most similar vectors.

After retrieving the top similar vectors at block 512, the system constructs a discrete probability distribution from these search results at block 514, to estimate the likelihood of forecasted quantities. This method provides a full probability distribution rather than a single point estimate, allowing downstream tasks to quantify uncertainty and optimize decisions based on risk profiles.

In some embodiments, typical weighting of retrieved neighbors can be directly proportional to the cosine similarity between the new prediction sample and the samples returned by the index. In addition, the size of the retrieved neighbor set may be tuned per application automatically to deliver the right tradeoff in terms of speed and prediction quality.

At block 516, sample from the discrete probability distribution (obtained at block 514) to produce a prediction interval (at block 518) that can be used for downstream tasks or shown directly to users.

A number of technical effects ensue from the steps outlined in FIG. 5. Embedding the training dataset of a trained tree-based model as an array of vectors, with each dimension representing a decision point in the model, allows the decision paths of the model to be expressed in a form that is compatible with vector-based processing. This arrangement enables the system to preserve information about how samples traverse the trained model while supporting high-speed similarity operations on a common vector representation. Where the vector dimensions are normalized and the embedding size is selected according to storage, speed, or accuracy considerations, the representation also supports consistent distance calculations across tree depths and permits memory usage to be adjusted without departing from the underlying model structure.

In addition, defining the distance between historical sample points as a cosine similarity function between the vectors allows the comparison to emphasize directional similarity in the embedded decision-path patterns rather than magnitude alone. This comparison approach improves robustness to scale variation in the time-series data and reduces the need to tailor the similarity metric to the volatility characteristics of individual time series. As a result, the same similarity formulation can be applied across different series while still supporting reliable identification of historically relevant samples.

In addition, processing the array of vectors through a Hierarchical Navigable Small World index allows the embedded samples to be organized in a structure that supports approximate neighbor retrieval at production scale. This indexing step enables rapid access to similar vectors without requiring full comparison across the training dataset, thereby reducing search burden and making interval-oriented forecasting practical for large numbers of time series. Because the index may be reused until the model is retrained, the arrangement also supports repeated querying with limited additional overhead.

In addition, searching, for a new prediction, for a number of most similar vectors allows the system to retrieve a focused set of historical samples that are most relevant to the current prediction context. This step enables the subsequent uncertainty estimation to be based on a bounded neighbor set rather than the entire historical population, which improves computational efficiency while maintaining a controllable balance between speed and prediction quality. Where the number of retrieved vectors is selected or tuned for a given application, the search can be adapted to the desired operational tradeoff without changing the overall probabilistic estimation workflow.

Furthermore, creating a discrete probability distribution from the retrieved similar vectors allows the system to produce a probabilistic characterization of the forecasted quantity instead of a single point forecast alone. This distribution enables downstream processing, including sampling to form a prediction interval and using the forecast output in risk-sensitive decision tasks. Because the distribution is derived from a common set of similar historical samples returned through the vector-based search process, the resulting probabilistic output also supports internally consistent interval and quantile estimation.

Furthermore, sampling from the discrete probability distribution to produce a prediction interval allows the probabilistic output of the method to be converted into an interval that can be used directly by downstream processes or presented to users. This step enables uncertainty-aware forecasting instead of providing only a single point value, which supports decisions based on the range and likelihood of forecasted quantities. Because the interval is produced from the distribution generated by the disclosed tree-based similarity framework, the result remains compatible with computationally efficient large-scale forecasting.

Further technical effects ensue from some embodiments.

In some embodiments, where a gradient boosting model is used as the trained tree-based model, allows the probabilistic estimation process to be applied to an ensemble in which trees are built sequentially and contribute with different relative weighting. This arrangement supports computationally efficient generation of probability forecasts and prediction intervals while avoiding reliance on leaf-tracking operations that become slow and costly at large scale. The sequential weighting of the trees also permits the embedding size to be adjusted according to storage, speed, and accuracy considerations.

In addition, in some embodiments, where dimensions of the vectors are normalized across different tree depths, allows for distance calculations between embedded samples to remain consistent even when decision points occur at different depths in the trained model. This step enables reliable similarity comparison in the vector space and supports use of a common embedding format for training samples and prediction samples. As a result, the embedded representation remains suitable for high-speed vector search while preserving the structure derived from the tree-based model.

In addition, in some embodiments, one hundred most similar vectors from the Hierarchical Navigable Small World index are retrieved, which allows the method to use a defined set of nearby historical samples when constructing the discrete probability distribution for a new prediction. This retrieval size supports a practical balance between search speed and prediction quality, rather than requiring a full comparison against the dataset. In combination with the indexed similarity search, the feature helps maintain rapid processing for large forecasting workloads.

Furthermore, in some embodiments, the retrieved similar vectors are weighted in proportion to their respective cosine similarities to the vector of the new prediction, which allows historical samples that are more closely aligned with the new prediction to have greater influence on the resulting discrete probability distribution. This weighting improves the relevance of the distribution to the current prediction context and supports more informative uncertainty estimation. The feature also works with the similarity-based retrieval process to preserve a useful tradeoff between prediction quality and processing efficiency.

From a technical perspective, the conventional approach to forecasting a range (rather than a single point) in a machine-learning model, is to use traditional time series models, such as Autoregressive Integrated Moving Average (ARIMA), since it inherently produces prediction intervals. However, ARIMA models are not always accurate, and can be computationally unstable. Other conventional approaches for forecasting a range of values (rather than a single point), include neural networks and Bayesian machine-learning models. However, these have the drawback in that they are expensive and harder to tune. In fact, all of the conventional approaches for forecasting a range of values, require more data, more run-time, and are overall, computationally resource-intensive.

On the other hand, while tree-based machine-learning models are computationally efficient and fast, conventional uses of tree-based machine-learning models do not forecast a range. That is, conventional use of tree-based machine-learning models does not provide a probability of forecasts. It is therefore not obvious that tree-based machine-learning models can be used to provide a probability of forecasts.

However, systems and methods disclosed herein, use tree-based models in a non-conventional way that results in probability forecasts. Furthermore, such a unique approach is less data-intensive, requires less run-time and is more computationally efficient than the Bayesian models, neural networks and traditional time series machine-learning models.

The systems and methods disclosed herein relate to an estimation of the probability of a forecasted quantity. The systems and methods disclosed herein may be presented in two parts. One part relates to systems and methods of estimating the probability of a forecasted value. A second, optional use case afforded by the first part, discloses systems and methods where values used by a process are optimized.

In both parts, there is no restriction as to the context of the values. While there is no restriction as to the context of the quantities, non-limiting examples in the field of supply chain management are provided. Systems and methods related to the optional use case can comprise: an optimization module using the quantiles to produce a set of recommendations.

The methods and systems disclosed herein are an improvement on conventional approaches by enhancing a number of features. For example, accuracy is enhanced, as a desired coverage probability is achieved with a short window of historical data. Simultaneously, since a short window of historical data is required (as opposed to conventional methods described above), less historical data is required for processing, thereby reducing both processing time and data storage.

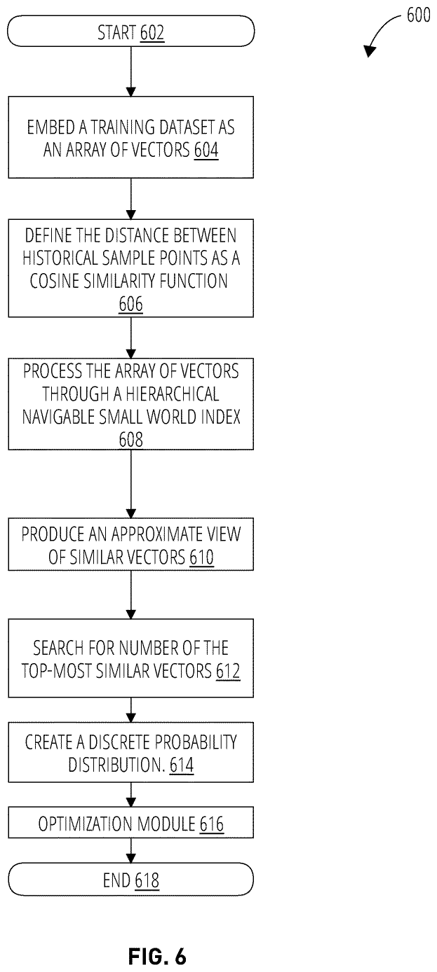

FIG. 6 illustrates a flowchart 600 for an uncertainty estimation from a trained model in accordance with one embodiment.

At block 604, the training dataset of a trained tree-based model is embedded as an array of vectors, where each dimension represents a decision point in the model. An example of a block diagram for training a tree-based model is illustrated in FIG. 3. In FIG. 6, decision paths of a trained tree-based model are converted into an array of vectors where each dimension corresponds to a specific decision point within the model structure. Such an approach transforms complex tree logic into a format compatible with high-speed vector search algorithms, enabling the retention of model interpretability while gaining computational efficiency. Dimensions of the vector can be normalized to ensure consistent distance calculations across different tree depths, since this approach is applicable within a single model. Therefore, all embeddings have the same size as all samples of the training set and of the prediction set are seen by the same model.

With regards to memory overhead of storing these vectors compared to the original tree structure, memory overhead can be adjustable as embeddings are natively hierarchical: the first dimensions encode larger potential differences in similarity. This is due to how gradient-boosted tree ensembles are trained sequentially and weighted according to that sequence: the earlier trees are more important for the final prediction than later trees. Therefore, depending on storage, speed and accuracy concerns, the size of the embeddings can be adjusted up to the total number of trees in the model.

Next, at block 606, the distance between historical sample points in a time series is defined as the cosine similarity function between two of these vectors. Use of cosine similarity allows the system to focus on the directional pattern of the data rather than absolute magnitude, which improves robustness against scale variations in time series data. There is no need to adjust the similarity metric dynamically based on the volatility of a specific time series, since the system is agnostic to the properties of the time series.

Subsequently, at block 608, the array of vectors is processed through a Hierarchical Navigable Small World (HNSW) index to create an approximate view of similar vectors for rapid retrieval. HNSW indexing drastically reduces the search time complexity from linear to logarithmic, making it feasible to generate accurate prediction intervals for millions of time series without prohibitive latency.

While index creation can take longer than querying it once for all time series in a dataset, operations are still completed within a minute for the production workload datasets. Once an index is created, it is possible to reuse it until a new model is trained which may be multiple days or weeks and the fast queries then allow users to investigate their time series similarity questions without considerable wait times.

This produces, at block 610, an approximate view of similar vectors. At block 612, given a new prediction, search for the top-most similar vectors. For example, this can include the top one-hundred most similar vectors.

After retrieving the top similar vectors at block 612 the system constructs a discrete probability distribution from these search results at block 614, to estimate the likelihood of forecasted quantities. This method provides a full probability distribution rather than a single point estimate, allowing downstream tasks to quantify uncertainty and optimize decisions based on risk profiles.

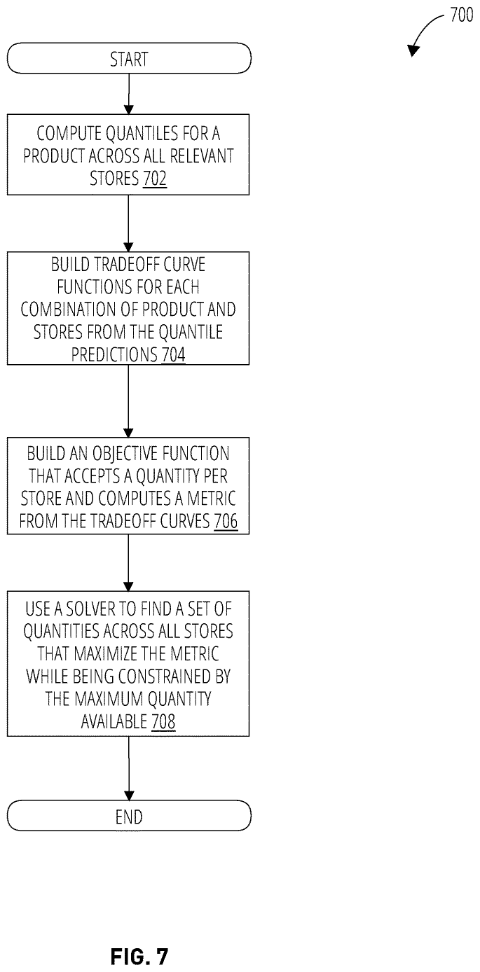

At block 616, the probability distribution obtained from block 614 can be used by an optimization module, an embodiment of which, is shown in FIG. 7.

In some embodiments, typical weighting of retrieved neighbors can be directly proportional to the cosine similarity between the new prediction sample and the samples returned by the index. In addition, the size of the retrieved neighbor set may be tuned per application automatically to deliver the right tradeoff in terms of speed and prediction quality.

A number of technical effects ensue from the steps outlined in FIG. 6. Embedding the training dataset of a trained tree-based model as an array of vectors, with each dimension representing a decision point in the model, allows the decision paths of the model to be expressed in a form that is compatible with vector-based processing. This arrangement enables the system to preserve information about how samples traverse the trained model while supporting high-speed similarity operations on a common vector representation. Where the vector dimensions are normalized and the embedding size is selected according to storage, speed, or accuracy considerations, the representation also supports consistent distance calculations across tree depths and permits memory usage to be adjusted without departing from the underlying model structure.

In addition, defining the distance between historical sample points as a cosine similarity function between the vectors allows the comparison to emphasize directional similarity in the embedded decision-path patterns rather than magnitude alone. This comparison approach improves robustness to scale variation in the time-series data and reduces the need to tailor the similarity metric to the volatility characteristics of individual time series. As a result, the same similarity formulation can be applied across different series while still supporting reliable identification of historically relevant samples.

In addition, processing the array of vectors through a Hierarchical Navigable Small World index allows the embedded samples to be organized in a structure that supports approximate neighbor retrieval at production scale. This indexing step enables rapid access to similar vectors without requiring full comparison across the training dataset, thereby reducing search burden and making interval-oriented forecasting practical for large numbers of time series. Because the index may be reused until the model is retrained, the arrangement also supports repeated querying with limited additional overhead.

In addition, searching, for a new prediction, for a number of most similar vectors allows the system to retrieve a focused set of historical samples that are most relevant to the current prediction context. This step enables the subsequent uncertainty estimation to be based on a bounded neighbor set rather than the entire historical population, which improves computational efficiency while maintaining a controllable balance between speed and prediction quality. Where the number of retrieved vectors is selected or tuned for a given application, the search can be adapted to the desired operational tradeoff without changing the overall probabilistic estimation workflow.

Furthermore, creating a discrete probability distribution from the retrieved similar vectors allows the system to produce a probabilistic characterization of the forecasted quantity instead of a single point forecast alone. This distribution enables downstream processing, including sampling to form a prediction interval and using the forecast output in risk-sensitive decision tasks. Because the distribution is derived from a common set of similar historical samples returned through the vector-based search process, the resulting probabilistic output also supports internally consistent interval and quantile estimation.

Further technical effects ensue from some embodiments.

In some embodiments, where a gradient boosting model is used as the trained tree-based model, allows the probabilistic estimation process to be applied to an ensemble in which trees are built sequentially and contribute with different relative weighting. This arrangement supports computationally efficient generation of probability forecasts and prediction intervals while avoiding reliance on leaf-tracking operations that become slow and costly at large scale. The sequential weighting of the trees also permits the embedding size to be adjusted according to storage, speed, and accuracy considerations.

In addition, in some embodiments, where dimensions of the vectors are normalized across different tree depths, allows for distance calculations between embedded samples to remain consistent even when decision points occur at different depths in the trained model. This step enables reliable similarity comparison in the vector space and supports use of a common embedding format for training samples and prediction samples. As a result, the embedded representation remains suitable for high-speed vector search while preserving the structure derived from the tree-based model.

In addition, in some embodiments, one hundred most similar vectors from the Hierarchical Navigable Small World index are retrieved, which allows the method to use a defined set of nearby historical samples when constructing the discrete probability distribution for a new prediction. This retrieval size supports a practical balance between search speed and prediction quality, rather than requiring a full comparison against the dataset. In combination with the indexed similarity search, the feature helps maintain rapid processing for large forecasting workloads.

Furthermore, in some embodiments, the retrieved similar vectors are weighted in proportion to their respective cosine similarities to the vector of the new prediction, which allows historical samples that are more closely aligned with the new prediction to have greater influence on the resulting discrete probability distribution. This weighting improves the relevance of the distribution to the current prediction context and supports more informative uncertainty estimation. The feature also works with the similarity-based retrieval process to preserve a useful tradeoff between prediction quality and processing efficiency.

In the domain of supply chain management, efficient allocation of limited inventory across a distributed network of retail locations remains a critical operational challenge. A primary objective is to maximize service levels while adhering to strict constraints on total available stock. This optimization problem is fundamentally dependent on the accuracy and reliability of demand forecasts, particularly the ability to predict not just the expected demand, but the full probability distribution of potential demand outcomes. Without robust probabilistic forecasts, decision-makers are forced to rely on point estimates that fail to capture the inherent uncertainty of consumer behavior, leading to either excessive safety stock that ties up capital or insufficient inventory that results in lost sales and diminished customer satisfaction.

Traditional forecasting methodologies, including ARIMA models, Bayesian approaches, and deep neural networks, have long been employed to address these prediction needs. While these techniques can theoretically generate prediction intervals or full distributions, they often suffer from significant computational instability and high resource consumption. The training and inference processes for such models frequently require vast amounts of historical data and substantial processing power, making them impractical for environments requiring real-time or near-real-time decision-making across millions of distinct time series. Furthermore, the computational cost scales poorly as the number of products and locations increases, creating a bottleneck that prevents the widespread adoption of probabilistic forecasting in large-scale supply chain networks.

Tree-based machine learning models have emerged as a more efficient alternative for generating point forecasts due to their speed and ability to handle non-linear relationships without extensive data preprocessing. As discussed above, a significant limitation persists in their traditional application: they inherently produce single point estimates rather than probabilistic ranges. Existing techniques adapted to extract quantile predictions from these tree structures, such as methods that track data points through leaf nodes to reconstruct distributions, introduce prohibitive computational overhead. When applied at the scale of millions of time series, these leaf-tracking approaches become excessively slow and resource-intensive, rendering them unsuitable for the rapid iteration required in dynamic inventory allocation scenarios.

Consequently, there exists a distinct gap in current technological capabilities regarding the derivation of consistent quantile predictions from efficient tree-based models. This deficiency highlights a critical need for the systems and methods disclosed herein that can provide accurate quantile forecasts without incurring the computational penalties associated with traditional probabilistic models or inefficient adaptations of tree-based systems.

Disclosed herein are systems and methods that generate accurate prediction intervals without the computational instability or excessive data requirements associated with traditional statistical methods like ARIMA or Bayesian models. An embodiment is illustrated in FIG. 2. This architecture specifically overcomes the cost-prohibitive nature of scaling probabilistic forecasting to millions of time series, providing a computationally efficient mechanism to transform point forecasts into robust quantile predictions.

In relation to applications in supply chains, historical data comprises, for example, historical sales data (quantity of units sold per product per store). Data characterizing the same time period as the historical sales data can include, for example, promotions related to the products, store events, cultural events, and the like. An optimization module can use quantiles to produce a set of safety stock recommendations across multiple stores dependent on the same stock constraint—as an example: one distribution center. In addition to enhancing accuracy and computational efficiency (as described above for the general case), there is enhanced consistency since there is reuse of modeling work completed by demand modules and production of predictions aligned with the demand forecasts.

An approach to uncertainty modelling can involve a tree-based forecasting model, which can be a simple decision tree for regression, or a more complex ensemble of several trees, such as random forest or gradient boosting.

The presented approach ensures consistency of the derived quantile predictions, as they are obtained from the same distributions. This can be identified as an advantage over a quantile regression method that involves fitting different models for each of the quantile objectives, and hence does not guarantee the consistency between quantile forecasts.

The systems and methods disclosed herein can incorporate an optimization module in the case where an optimization is requested for a set of stores.

A variety of optimization libraries may be used. In some embodiments, a Mystic optimization library is used (https://mystic.readthedocs.io/en/latest/), which allows for quickly finding solutions to optimization problems using constraints through multiple solvers (local and global algorithms can be used here; non-limiting examples include the Nelder-Mead method). An objective function is computed (for example, the average service level across stores given shipped quantities) through probability distributions provided by the systems and methods disclosed herein. Furthermore, the sum of all quantities is constrained by the available stock at the distribution center serving that set of stores. The solution can be returned as a list of quantities, where the number of quantities is equal to the number of stores.

FIG. 7 illustrates a flowchart for optimization of service levels in accordance with one embodiment.

The flowchart shown in FIG. 7 illustrates an embodiment of optimization of service levels. At block 702, quantiles for a product can be computed across all relevant stores, from the discrete probability distribution obtained at block 614 in FIG. 6. As an example, two-hundred quantiles between the 50th and 100th percentiles can be computed.

The system utilizes vector embedding and similarity search techniques to extract consistent probability distributions and quantile predictions directly from tree-based models without expensive leaf-tracking, as shown in FIG. 6. This approach eliminates the computational instability and high costs associated with conventional probabilistic forecasting while scaling effectively to millions of time series.

Vector embeddings can be specifically constructed to represent the distributional characteristics of the tree leaves. The sequence of leaves across the trees represent the decision paths a particular sample adheres to according to its attributes; a model can be built so that tree leaves typically contain a number of samples (which are known then to be more similar to each other than samples landing in different leaves). Therefore, the embeddings built by indicating which leaf ids store a particular sample is an approximation of that similarity.

As shown in FIG. 2 and FIG. 6, cosine similarity can be used to match new observations with historical patterns for quantile estimation. In addition, the system can handle outliers in the training data that might skew the derived probability distributions, as follows. Using larger numbers of similar samples can reduce the weight of potential outliers, which can be tuned automatically.

Next, at block 704, tradeoff curve functions can be constructed for each combination of product and stores from the quantile predictions obtained at block 702. As an example, such construction can occur with piecewise linear interpolation splines, or other methods. As new sales data becomes available, the tradeoff curves are regenerated, rather than adjusting the spline parameters.

Using splines allows for a smooth and computationally tractable representation of the relationship between inventory quantity and service level, facilitating faster optimization. In some embodiments, the number and placement of knots in the piecewise linear interpolation splines is determined by least-square minimization.

At block 706, an objective function can be constructed, that accepts a quantity per store and computes an objective metric from the tradeoff curves. The metric can be, for example, an average service level. That is, the average chance of not stocking out.

At block 708, a solver can be used to find a set of quantities across all stores that maximize the metric while being constrained by the maximum quantity available. That is, the stock available at a distribution centre serving all the relevant stores. An example of a solver is one that finds the maximum or minimum of a function in a multidimensional space. In addition, the solver may use a direct search method that may be applied to nonlinear optimization problems. An example of a solver that may be used is one that uses the Nelder-Mead method.

In some embodiments, a mathematical solver employs the Nelder-Mead method and identifies the optimal inventory allocation across all stores by maximizing an objective function like average service level under strict inventory constraints. Such an approach provides a robust solution for complex, non-linear resource allocation problems where total stock is limited, ensuring maximum service levels without exceeding supply.

The strict inventory constraint can be handled within the derivative-free Nelder-Mead algorithm, by replacing strict constraints with high-coefficient penalties.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
(a) embed a training dataset of a trained tree-based model as an array of vectors, each vector corresponding to a respective sample of the training dataset and each dimension of the vector representing a decision point in the trained tree-based model;
(b) define a distance between historical sample points in a time series as a cosine similarity function between the vectors;
(c) process the array of vectors through a Hierarchical Navigable Small World index to produce an approximate view of similar vectors;
(d) for a new prediction, search the Hierarchical Navigable Small World index for vectors most similar to a vector associated with the new prediction;
(e) create, from the vectors most similar to the vector associated with the new prediction, a discrete probability distribution of a forecasted quantity;
(f) compute quantile predictions for a product across multiple locations based on the discrete probability distribution;
(g) construct tradeoff curve functions for each combination of product and location from the quantile predictions; and
(h) construct an objective function that accepts a quantity per location and computes an objective metric from the tradeoff curves.

2. The computing apparatus of claim 1, wherein the instructions further configure the apparatus to:
sample, from the discrete probability distribution to produce a prediction interval.

3. The computing apparatus of claim 1, wherein the trained tree-based model comprises a gradient boosting model.

4. The computing apparatus of claim 1, wherein when embedding the training dataset as the array of vectors, the instructions further configure the apparatus to:
normalize dimensions of the vectors across different tree depths.

5. The computing apparatus of claim 1, wherein when searching the Hierarchical Navigable Small World index, the instructions further configure the apparatus to:
retrieve between one hundred and one hundred and fifty most similar vectors.

6. The computing apparatus of claim 5, wherein when searching the Hierarchical Navigable Small World index, the instructions further configure the apparatus to:
retrieve one hundred most similar vectors.

7. A non-transitory computer-readable storage medium, the computer-readable storage medium including instructions that when executed by a computer, cause the computer to:
(a) embed a training dataset of a trained tree-based model as an array of vectors, each vector corresponding to a respective sample of the training dataset and each dimension of the vector representing a decision point in the trained tree-based model;
(b) define a distance between historical sample points in a time series as a cosine similarity function between the vectors;
(c) process the array of vectors through a Hierarchical Navigable Small World index to produce an approximate view of similar vectors;
(d) for a new prediction, search the Hierarchical Navigable Small World index for vectors most similar to a vector associated with the new prediction;
(e) create, from the vectors most similar to the vector associated with the new prediction, a discrete probability distribution of a forecasted quantity;
(f) compute quantile predictions for a product across multiple locations based on the discrete probability distribution;
(g) construct tradeoff curve functions for each combination of product and location from the quantile predictions; and
(h) construct an objective function that accepts a quantity per location and computes an objective metric from the tradeoff curves.

8. The computer-readable storage medium of claim 7, wherein the instructions further configure the computer to:
sample from the discrete probability distribution to produce a prediction interval.

9. The computer-readable storage medium of claim 7, wherein the trained tree-based model comprises a gradient boosting model.

10. The computer-readable storage medium of claim 7, wherein when embedding the training dataset as the array of vectors, the instructions further configure the computer to:
normalize dimensions of the vectors across different tree depths.

11. The computer-readable storage medium of claim 7, wherein when searching the Hierarchical Navigable Small World index, the instructions further configure the computer to:
retrieve between one hundred and one hundred and fifty most similar vectors.

12. The computer-readable storage medium of claim 11, wherein when searching the Hierarchical Navigable Small World index, the instructions further configure the computer to:
retrieve one hundred most similar vectors.

13. A computer-implemented method for estimating a probability distribution of a forecasted quantity, the method comprising:
(a) embedding, by a processor, a training dataset of a trained tree-based model as an array of vectors, each vector corresponding to a respective sample of the training dataset and each dimension of the vector representing a decision point in the trained tree-based model;
(b) defining, by the processor, a distance between historical sample points in a time series as a cosine similarity function between the vectors;
(c) processing, by the processor, the array of vectors through a Hierarchical Navigable Small World index to produce an approximate view of similar vectors;
(d) for a new prediction, searching, by the processor, the Hierarchical Navigable Small World index for vectors most similar to a vector associated with the new prediction;
(e) creating, by the processor, from the vectors most similar to the vector associated with the new prediction, a discrete probability distribution of the forecasted quantity;
(f) computing, by the processor, quantile predictions for a product across multiple locations based on the discrete probability distribution;
(g) constructing, by the processor, tradeoff curve functions for each combination of product and location from the quantile predictions; and
(h) constructing, by the processor, an objective function that accepts a quantity per location and computes an objective metric from the tradeoff curves.

14. The computer-implemented method of claim 13, further comprising:
sampling, by the processor, from the discrete probability distribution to produce a prediction interval.

15. The computer-implemented method of claim 13, wherein the trained tree-based model comprises a gradient boosting model.

16. The computer-implemented method of claim 13, wherein embedding the training dataset as the array of vectors comprises normalizing dimensions of the vectors across different tree depths.

17. The computer-implemented method of claim 13, wherein searching the Hierarchical Navigable Small World index comprises retrieving between one hundred and one hundred and fifty most similar vectors.

18. The computer-implemented method of claim 17, wherein searching the Hierarchical Navigable Small World index comprises retrieving one hundred most similar vectors.
